(19) United States
(12) Patent Application Publication
(10) Pub. No.: US 2025/0009005 A1
(43) Pub. Date: Jan. 9, 2025

(54) HIGH POTENCY GRANULES OBTAINABLE BY CONTINUOUS MELT GRANULATION

(71) Applicant: DSM IP Assets B.V., Heerlen (NL)

(72) Inventors: Bram BEKAERT, Kaiseraugst (CH); Christoph PORTIER, Kaiseraugst (CH); Lise VANDEVIVERE, Kaiseraugst (CH); Chris VERVAET, Kaiseraugst (CH)

(21) Appl. No.: 18/710,029

(22) PCT Filed: Nov. 15, 2022
(86) PCT No.: PCT/EP2022/081967

§ 371 Date: May 14, 2024

(30) Foreign Application Priority Data
Nov. 16, 2021 (EP) 21208525.2

(51) Int. Cl. A23P 10/25; A23L 29/30; A23L 33/15

(52) U.S. Cl. CPC A23P 10/25; A23L 29/37; A23L 33/15

(57) ABSTRACT

The present invention relates to water-soluble or water-dispersible granules that comprise a binder, a filler and an active ingredient. Preferred granules of the invention are obtained by continuous melt granulation of a mixture that comprises 65-70 weight-% active ingredient. 15-25 weight-% filler and 5-15 weight-% binder, based on the total weight of the mixture. Ascorbic acid and edible salts thereof are the preferred active ingredients.

### TECHNICAL FIELD

The present invention relates to water-dispersible powders for human consumption.

### BACKGROUND OF THE INVENTION

Granulation is a size enlargement process. It is often done via wet granulation using a solvent (water or organic solvent) to initiate binding between solid particles (e.g. microcapsules). In examples 9 and 13 of U.S. Pat. No. 4,203,997, a mixture comprising 90 parts ascorbic acid is moistened with 8 parts of water, and then passed through a compactor, dried and comminuted.

A drawback of wet granulation is the need of getting rid of the solvent at the end of the granulation process. In case of using water as solvent, a significant amount of energy is needed to evaporate water. A further drawback of wet granulation is the risk of hydrolysis of the active ingredient. In case of organic solvents, potentially harmful residues and/or negative environmental impacts are of concern.

Dry granulation and melt granulation are known alternatives for wet granulation. Melt granulation operates via similar principles as wet granulation but uses a molten binder as granulation fluid to establish liquid bridges between the particles to be granulated. When cooling to room temperature, the binder solidifies and forms bridges between individual powder particles to yield a solid end product with a granular structure.

Most often, melt granulation is done as a batch processes, e.g. in a heated powder bed. Example 1 of WO 2006/082499 discloses a batch process, wherein a mixture is granulated in a Bohle tumbling mixer. Processing of successive batches must wait until the completion of the current batch. This is a major drawback of batch processing. Indeed, batch processing is a process that results in the production of limited quantities of material.

The drawbacks of batch processing can be overcome by using a continuous process.

An example of a continuous process is hot-melt extrusion. Hot-melt extrusion processes generate solid solutions or solid dispersions. Thus, particles produced by hot-melt extrusion are not granules in the sense that bridges between individual powder particles could be identified. Chang et al. disclose a hot-melt extrusion process using an extruder having a die head with a die diameter of 3 mm (Dawei Chang et al., “Ascorbic acid encapsulation in a glassy carbohydrate matrix via hot melt extrusion: Preparation and characterization” Food Sci. Technol, Campinas, 39 (3): 660-666, July-September 2019). Extrudates exiting the die are then ground into powder (Chang et al., section 2.13). Indeed, a drawback of hot-melt extrusion is the need for cutting, grinding or any other kind of comminuting once an extruded strand has exited the die. Unacceptably high die head pressures and difficult downstream processing are other drawbacks that are inherent in hot-melt extrusion.

There is a need for a continuous granulation process that does not have the mentioned drawbacks. It should be a solvent-free process. Processing temperature should be relatively low. The amount of fines (i.e. non-granulated residues) occurring during the process should be low. Granules obtained by the sought-after granulation process should be edible, should have high potency, should have good flow properties and should be water-soluble or at least water-dispersible.

### SUMMARY OF THE INVENTION

The problems underlying the present invention are solved by continuous melt granulation of the mixture of the invention. The granules of the invention comprise or consist of the mixture of the invention. The present invention also relates to the use of the herein disclosed mixture for continuous melt granulation.

The mixture of the invention comprises at least one active ingredient, at least one filler and at least one binder. A preferred mixture comprises at least one polysaccharide (as a filler), at least one sugar alcohol (as a binder) and ascorbic acid or an edible salt thereof (as active ingredient), wherein the melting temperature of said at least one sugar alcohol is lower than the melting temperature of said at least one polysaccharide.

The mixture of the invention is suitable for continuous melt granulation without solvent. Thus, the mixture of the invention is a dry mixture which comprises preferably less than 5 weight-% water, based on the total weight of the mixture.

The mixture of the invention is suitable for manufacturing high potency granules via continuous melt granulation. Thus, the preferred mixture of the invention comprises at least 50 weight-% active ingredient, based on the total weight of the mixture.

The mixture of the invention preferably comprises at least 10 weight-% filler, based on the total weight of the mixture. The most preferred filler is inulin whereas the most preferred binder is sorbitol.

The mixture of the invention is suitable for continuous melt granulation at relatively low temperatures. In case the weight ratio between filler and binder is from 4:1 to 1:1, continuous melt granulation can be done at a surprisingly low temperature: preferably at a temperature lower than 180° C., more preferably at a temperature lower than 110° C. and most preferably at a temperature lower than 100° C.

The method of the invention is a method of manufacturing granules, wherein the mixture of the invention is fed into an extruder that has preferably at least one kneading zone.

Extrusion granulation as herein disclosed is done in an extruder without die. When doing continuous melt granulation, a co-rotating twin-screw extruder continuously churns out free flowing granules [cf. FIG. 1 of N. Kittikunakorn et al., “Twin-screw melt granulation: Current progress and challenges”, International Journal of Pharmaceutics, 588, (2020), 119670]. There is neither a need for a drying step nor for a cutting/comminuting step.

### DETAILED DESCRIPTION OF THE INVENTION

The granules of the invention are obtainable by continuous melt granulation of a dry, edible mixture that comprises primary particles and at least two edible excipients. During continuous melt granulation, primary particles are agglomerated. Thus, the granule of the invention is preferably a unit formed of numerous particles. Primary particles of a granule are smaller than the granule.

Both edible excipients are preferably water-soluble or water-dispersible. The melting temperature of a first edible excipient is low enough to be molten or at least be softened during continuous melt granulation. When molten or softened, the first edible excipient establishes bridges between the primary particles. Said bridges then solidify at room temperature. Therefore, the first edible excipient mostly acts as a binder. In the most preferred embodiment of the invention, the first edible excipient is sorbitol.

The melting temperature of a second edible excipient is relatively high. The second edible excipient mostly acts as a filler. In the most preferred embodiment, the second edible excipient is inulin.

The granule of the present invention may comprise one kind of primary particles only or more than one kind of primary particles. The primary particles of the granule of the invention preferably comprise or consist of an active ingredient. Examples of primary particles are vitamin C crystals. Thereby, vitamin C may be ascorbic acid, an edible salt of ascorbic acid or an edible, water-soluble ester of ascorbic acid.

The granules of the present invention are preferably water-soluble or water-dispersible. Compositions comprising or consisting of such granules are suitable for preparing a beverage. One embodiment of the invention relates to a beverage obtainable by dissolving or dispersion a composition that comprises the herein described granules.

### Filler of the Invention

Fillers are excipients used to increase the volume of the granule of the invention. Fillers can have further functions. Some fillers (e.g. dietary fibers) also have health benefits.

The granule of the invention is meant for human consumption. Toxic fillers and non-edible fillers in general are therefore excluded.

The granule of the invention is preferably water-soluble or water-dispersible. Fillers having a solubility of less than 1 g per 100 ml water or less than 0.5 g per 100 ml water or less than 0.1 g per 100 mL water are therefore not preferred.

Typically, the melting temperature of the filler is higher than the melting temperature of the binder. However, this does not exclude the possibility that the filler is also melted or softened during continuous melt granulation. The melting temperature of the filler is preferably at least 150° C., more preferably at least 155° C. and most preferably at least 160° C. and is preferably from 151° C. to 240° C., is more preferably from 160° C. to 240° C. and is most preferably from 180° C. to 200° C.

In the context of the present invention, the filler is preferably a polysaccharide, is more preferably a polysaccharide produced by a plant, is even more preferably a dietary fiber and is most preferably inulin. Examples of alternative fillers are human milk oligosaccharides (HMOs) and mannitol. 2′-fucosyllactose (2′-FL) is the preferred HMO. An even more preferred filler is a mixture comprising 2′-fucosyllactose and difucosyllactose (DFL).

### Binder of the Invention

Binders are excipients used to hold the ingredients of a formulation together. To do so, the binder is melted or softened during continuous melt granulation. Typically, the melting temperature of the binder is lower than the melting temperature of the filler and is often also lower than the melting temperature of any added active ingredient. The melting temperature of the binder is preferably less than 140° C., more preferably less than 130° C., even more preferably less than 120° C. and most preferably less than 110° C. The melting temperature of the binder is preferably from 50° C. to 110° C., is more preferably from 60° C. to 100° C. and is most preferably from 70° C. to 100° C.

The granule of the invention is preferable water-soluble or water-dispersible. Binders having a solubility of less than 1 g per 100 ml of water or less than 0.5 g per 100 ml of water or less than 0.1 g per 100 ml of water are therefore not preferred. Possible binders are inter alia ribose (such as D-ribose), polyethylene glycol, sorbitol and xylitol. In the context of the present invention, the binder is preferably a polyol, is more preferably a sugar alcohol, is even more preferably sorbitol or ribose (e.g. D-ribose), and is most preferably sorbitol having preferably a melting temperature of 98° C. or less. Such sorbitol is commercially available at Roquette®. Sorbitol is a stereoisomer of mannitol.

### Active Ingredient of the Invention

The mixture of the invention comprises at least one active ingredient. In the context of the present invention, water-soluble and water-dispersible active ingredients are preferred. Water-soluble and water-dispersible vitamins (such as vitamin C, vitamin B1, vitamin B2, vitamin B3, vitamin B6 and vitamin B12) are examples of water-soluble or water-dispersible active ingredients. In one embodiment of the invention, the active ingredient is a micronutrient, is preferably a water-soluble micronutrient and is even more preferably a water-soluble vitamin.

In a preferred embodiment, the active ingredient of the invention is vitamin C. The term “vitamin C” may thereby refer to ascorbic acid, an edible salt of ascorbic acid or an edible ester of ascorbic acid. Fat-soluble esters of ascorbic acid are preferably excluded. The preferred mixture of the invention comprises ascorbic acid particles. Such particles may be crystalline and/or amorphous. Ascorbic acid particles are commercially available at DSM® Nutritional Products, Switzerland.

### Mixture of the Invention

The mixture of the invention is suitable for continuous melt granulation. When doing continuous melt granulation, the mixture of the invention is fed into an extruder or any other suitable apparatus.

In contrast to wet granulation, no solvent is needed when doing continuous melt granulation. Thus, the mixture of the invention comprises preferably less than 10 weight-%, more preferably less than 8 weight-%, even more preferably less than 5 weight-% and most preferably less than 3 weight-% solvent, based on the total weight of the mixture. This applies not only, but in particular when the solvent is water. Thus, the preferred mixture of the invention comprises preferably less than 10 weight-%, more preferably less than 8 weight-%, even more preferably less than 5 weight-% and most preferably less than 3 weight-% water, based on the total weight of the mixture. In the most preferred embodiment, the mixture of the invention comprises residual moisture only.

Preferred mixtures of the invention comprise or consist of
at least one active ingredient
at least one edible filler that is preferably water-soluble or water-dispersible,
at least one edible binder that is preferably water-soluble or water-dispersible, and
optionally residual moisture.

The binders and fillers of the invention are edible excipients. The mixture of the invention comprises preferably from 20 to 40 weight-% and more preferably from 25 to 30 weight-% edible excipients, based on the total weight of the mixture.

Mixtures comprising high concentrations of active ingredient are suitable to manufacture high potency granules. In one embodiment, the mixture of the invention comprises at least 50 weight-%, preferably at least 55 weight-%, more preferably at least 60 weight-%, even more preferably at least 65 weight-% and most preferably at least 70 weight-% active ingredient, based on the total weight of the mixture. Regarding the active ingredient, the above mentioned preferences apply. Thus, a preferred mixture of the invention comprises a filler, a binder and at least 50 weight-% of a water-soluble or water-dispersible vitamin, based on the total weight of the mixture. A more preferred embodiment of the invention relates to a mixture that comprises of a filler, a binder and from 50 to 80 weight-%, preferably from 65 to 75 weight-% ascorbic acid, based on the total weight of the mixture. However, the active ingredient of the present invention is not limited to ascorbic acid. Exemplary alternative active ingredients are listed above. Thus, an also preferred embodiment of the invention relates to a mixture that comprises of a filler, a binder and from 50 to 80 weight-% of a water-soluble or water-dispersible vitamin, based on the total weight of the mixture.

Fillers are needed for size enlargement; they increase the volume of the granule of the invention. The mixture of the invention comprises preferably at least 10 weight-% filler, based on the total weight of the mixture. In one embodiment, the mixture of the invention comprises from 10 to 40 weight-%, preferably from 15 to 25 weight-%, and most preferably from 20 to 25 weight-% of at least one filler, based on the total weight of the mixture. Regarding the filler, the above mentioned preferences apply. Thus, the mixture of the invention comprises preferably at least 10 weight-% of a dietary fiber, based on the total weight of the mixture, wherein said dietary fiber is preferably inulin. The mixture of the invention may comprise more than one filler.

Preferably, however, the invention comprises one filler only. A particularly preferred mixture of the invention comprises crystalline ascorbic acid, a binder and from 10 to 40 weight-% inulin, based on the total weight of the mixture.

Typically, the mixture of the invention comprises less binder than filler. The weight ratio between the filler and the binder is preferably from 4:1 to 1:1, is more preferably from 3:1 to 1:1, is even more preferably from 2:1 to 1:1 and is most preferably 2:1. Thereby, the mixture of the invention comprises preferably from 5 weight-% to 15 weight-%, more preferably from 6 weight-% to 14 weight-% and most preferably from 8 weight-% to 13 weight-% of at least one binder, based on the total weight of the mixture. Regarding the binder, the above mentioned preferences apply. Thus, the mixture of the invention comprises preferably from 5 weight-% to 15 weight-%, more preferably from 6 weight-% to 14 weight-% and most preferably from 8 weight-% to 13 weight-% of at least one polyol, based on the total weight of the mixture. A particularly preferred mixture of the invention comprises inulin and sugar alcohol in a weight ratio preferably from 4:1 to 1:1, more preferably from 3:1 to 1:1, even more preferably from 2:1 to 1:1 and most preferably 2:1. Sorbitol and ribose are preferred sugar alcohols.

### Granules of the Invention

Preferred granules are obtainable by continuous melt granulation (i.e. without solvent) of the mixture of the invention, preferably using a twin-screw extruder. Thus, the granule of the invention comprises or consists of the mixture of the invention.

The mixture of the invention comprises primary particles. Upon continuous melt granulation, bridges are formed between the mixture's primary particles. Thus, the granule of the invention is larger than the size of its primary particles. Preferred granules of the present invention have a mass median particle size D50 (volume based) from 0.5 mm to 6 mm, more preferably from 1 mm to 5 mm, even more preferably from 1.5 mm to 4.5 mm and most preferably from 2 mm to 4 mm, measured using dynamic image analysis. In case of crystals consisting of an active ingredient, granules of the present invention may comprise more than 100, more than 1000, more than 5000 or even more than 10000 crystals.

Each of the granules may comprise various kinds of active ingredients. In a preferred embodiment, however, the granule of the invention comprises one active ingredient only. In one embodiment, the granule of the invention comprises vitamin C, vitamin B1, vitamin B2, vitamin B3, vitamin B6 or vitamin B12. Typically, the granule of the invention comprises less than 1 weight-% fat-soluble active ingredients, based on the total weight of the mixture and is preferably free of fat-soluble active ingredients.

In one embodiment, the granule of the invention comprises a filler, a binder and at least one active ingredient,
wherein the mixture comprises at least 50 weight-% active ingredient, based on the total weight of the mixture, and
wherein the mixture comprises at least 10 weight-% filler, based on the total weight of the mixture, and
wherein the melting temperature of the active ingredient is higher than the melting temperature of the binder, and
wherein the melting temperature of the binder is lower than the melting temperature of the filler, and
wherein the mixture comprises less than 5 weight-% water, based on the total weight of the mixture.

The granule of the present invention is preferably water-soluble or water-dispersible. This can be achieved by selecting a binder that is water-soluble or water-dispersible, by selecting a filler that is water-soluble or water-dispersible, and by selecting water-soluble and/or water-dispersible active ingredients.

### Method of the Invention

The method of the invention is continuous melt granulation and is preferably continuous twin-screw melt granulation. Differences between batch melt granulation and continuous twin-screw melt granulation are listed in Table 1 of N. Kittikunakorn et al., “Twin-screw melt granulation: Current progress and challenges”, International Journal of Pharmaceutics, 588, (2020), 119670. In a preferred embodiment of the invention, the herein disclosed dry, powderous mixture is fed into an extruder that is suitable for continuous melt granulation. Volumetric powder feeders are thereby not preferred. In a preferred method of the invention, the mixture of the invention is fed into the herein described extruder using a gravimetric powder feeder. Gravimetric powder feeders result in a controlled and consistent feeding process, keeping changes in powder properties and process deviations over time into consideration.

In the method of the invention, a twin-screw extruder is preferably being used. Particularly preferred are twin-screw extruders with corotating screws. The corotating screws of the preferred extruder are modular and can hence be configured in a variety of setups, resulting in various zones. The purpose of the first zone near the inlet of the extruder is transport. Transport zones are often referred to as conveying zones. One or more kneading zones can be present. The kneading zone is typically located between two conveying zones with preferably a shaping zone at the extruder outlet.

Most often, each zone has different screw elements. The conveying zone has conveying elements that transport material towards the granulator outlet [cf. section 2.1 of N. Kittikunakorn et al., “Twin-screw melt granulation: Current progress and challenges”, International Journal of Pharmaceutics, 588, (2020), 119670]. The kneading zone has kneading elements, e.g. narrower or wider kneading disks. A typical shaping zone has at least one size control element that minimizes the amount of oversized granules. An exemplary size control element is shown in FIG. 1(f) of J. Vercruysse et al. “Impact of screw configuration on the particle size distribution of granules produced by twin screw granulation”, International Journal of Pharmaceutics 479 (2015) 171-180. These size controlling elements are not knives as used for cutting extruded strands. Indeed, no spaghetti-like strands are extruded when doing continuous melt granulation. Extruders that are suitable for continuous melt granulation do not have a die at the outlet. Size control elements are screw elements within the extruder.

Hot-melt extrusion is different from the herein described continuous melt granulation. When doing hot-melt extrusion, strands with e.g. a cylindric diameter are extruded through a die. The length of the strand is not limited (i.e. could be endless). To obtain separated pellets, strands obtained by hot-melt extrusion need to be cut into pieces. The obtained pellets are not granules formed of distinguishable primary particles. When doing hot-melt extrusion, the cutting step can be done at any time after extrusion, including directly at the die of the extruder. Dies with an integrated knife are commercially available.

The above does not apply to the method of the present invention. When doing continuous melt granulation, no strand is extruded. Instead, granules are continuously churned out at the end of the extruder. Because no strand is produced, there is no need for a knife/cutting step, which significantly simplifies the process. When doing continuous melt granulation, a die at the end of the extruder is not needed. In a preferred embodiment of the invention, the mixture of the invention is fed into a twin-screw extruder that has no die and no knife cutting device.

In the method of the invention, the screw configuration of a twin-screw extruder is typically selected such that the extruder has at least one kneading zone. Thereby, the at least one kneading zone is preferably closer to the powder inlet of the extruder than to the end of the extruder. Kneading zones have kneading elements. Said kneading elements are preferably kneading disks as disclosed in US 2005/0041521. Kneading disks may be congruent or non-congruent and are preferably positioned at a stagger angle from 30° to 90°. A stagger angle of approx. 30° is thereby preferred, as this is limiting the stress exerted on the powder mixture. In the context of the invention, “stagger angle” refers to the angle of crest misalignment that make two directly successive kneading disks, as explained in paragraph [0007] of US 2005/0041521. By way of example, the expression “kneading disks are positioned at a stagger angle 30°” means that there are successive kneading disks that make an angle of crest misalignment of 30°. There may be more than two successive kneading disks in a kneading zone of an extruder. FIG. 2 of US 2005/0041521 is a lateral view of a kneading zone with five successive kneading disks, wherein the kneading disks are positioned at a predetermined stagger angle.

Temperature control is relevant when doing continuous melt granulation. In a preferred method of the invention, the extruder has several zones which can be heated up or cooled down individually. When continuously melt granulating the herein disclosed mixture, temperature zones closer to the powder inlet of the extruder are typically heated. When choosing a suitable temperature, it must be taken into consideration that the material in the extruder may be moving rather quickly such that the contact of the material with the heating element is rather short. In some cases, it may therefore be advisable to set the temperature of some zones of the extruder to a temperature above the melting temperature of the mixture's binder.

In a preferred embodiment of the invention, the conveying zone and/or the kneading zone of the extruder are heated, preferably to a temperature from 80° C. to 180° C., more preferably to a temperature from 80° C. to 110° C. and most preferably to a temperature from 90° C. to 100° C.

Churning out hot granules is not preferred. Hot granules may still be relatively soft and sticky. As a consequence, hot granules may form a lump. This is to be avoided. It is therefore preferred to cool the material in the extruder before it is churned out by the extruder. In a preferred embodiment of the invention, at least one of the zones after the kneading zone is cooled down to a temperature of less than 60° C., preferably less than 40° C. and most preferably less than 26° C.

### EXAMPLES

### Comparative Example 1 (No Filler)

In example 1, a dry mixture comprising 90 weight-% active ingredient and 10 weight-% binder were continuously melt granulated (without solvent) using a twin-screw extruder without die. The dry mixture of example 1 did not comprise any filler.

As an active ingredient, the dry mixture of example 1 comprised a fine ascorbic acid powder (available at DSM® Nutritional Products, Switzerland). Ascorbic acid is a chemically defined compound having the empirical formula C₆H₈O₆ and a molecular weight of 176.13. The melting point of the active ingredient of example 1 is approx. 190° C. (with decomposition).

As a binder, the dry mixture of example 1 comprised a polyol (sorbitol, commercially available at Roquette®). The binder of example 1 has a melting temperature of approx. 98° C.

The dry mixture of example 1 was fed into a ThermoFisher® Eurolab® extruder, using a gravimetric loss-in-weight feeder at the powder inlet. The extruder had a length-to-diameter (L/D) ratio of 25/1 and a screw diameter of 16 mm. The corotating screws of the extruder were fully modular and could hence be configured in a variety of setups. The extruder was segmented in several zones which can be heated up or cooled down individually.

In example 1, two extrusion experiments were run using two temperature schemes. Temperature zones closer to the powder inlet (zones 2, 3 and 4) were heated to a temperature of 160° C. (first trial) or 185° C. (second trial). The temperature of zones closer to the end of the extruder (zones 5 and 6) was kept at 25° C. Cooling the end of the extruder enables early binder solidification and prevents stickiness of the granules that are being churned out of the extruder.

In example 1, the extruder had one kneading zone with three kneading disks that were positioned at a stagger angle of 30° (i.e. the angle of crest misalignment between any two directly successive kneading disks made 30° C.).

In example 1, it has been found that at a concentration of 90-weight % and using a binder as the sole excipient, ascorbic acid is not processable by continuous melt granulation; high amounts of fines occurred and the resulting granulated material had poor flow properties.

### Example 2 (10 wt.-% Filler)

In example 2, the experiment of example 1 was repeated using an extruder that had one kneading zone with five kneading disks that were positioned at a stagger angle of 90°. However, in contrast to example 2, a predetermined amount of filler was added as second excipient (i.e. in addition to the binder). The amount of active ingredient was reduced accordingly. As a filler, inulin was used (Orafti®GR, average degree of polymerization ≥10, available at Beneo, Mannheim, Germany). The melting point of the filler of example 1 had been determined in the range 190-195° C. The filler of example 2 had a higher melting temperature than the binder of example 2.

In example 2, the amount of filler was 10 weight-%, based on the total amount of the dry mixture; the weight ratio between filler and binder was 1:1. The composition of the dry mixture of example 2 is shown below:

| | Amount (wt.-%, based on total weight of |
|---|---|
| Ingredient | granule) |
| Ascorbic acid (fine powder) | 80 wt.-% |
| Binder (sorbitol) | 10 wt.-% |
| Filler (Inulin) | 10 wt.-% |
| Total | 100 wt.-% |

Similar to example 1, two extrusion experiments were run in example 2, using two different temperature schemes. Temperature zones closer to the powder inlet (zones 2, 3 and 4) were heated to a temperature of 160° C. (first trial) or 185° C. (second trial).

In example 2, it has been found that at a concentration of 80 weight % and using a further excipient (filler, in addition to the binder), ascorbic acid is processable by continuous melt granulation. However, a high amount of fines occurred and the resulting granulated material had relatively poor flow properties.

### Example 3 (40 wt.-% Filler)

In example 3, the experiment of example 2 was repeated using an extruder that had one kneading zone with three kneading disks that were positioned at a stagger angle of 30°. However, in contrast to example 2, the amount of filler was increased. More specifically, the amount of filler was increased from 10 wt.-% to 40 wt.-%, whereas the amount of active ingredient had been reduced accordingly.

In example 3, the weight ratio between filler and binder was 4:1. The composition of the dry mixture of example 3 is shown below:

| | Amount (wt.-%, based on total weight of |
|---|---|
| Ingredient | granule) |
| Ascorbic acid (fine powder) | 50 wt.-% |
| Binder (sorbitol) | 10 wt.-% |
| Filler (Inulin) | 40 wt.-% |
| Total | 100 wt.-% |

Similar to examples 1 and 2, two extrusion experiments were run in example 3, using two different temperature schemes. Temperature zones closer to the powder inlet (zones 2, 3 and 4) were heated to a temperature of 109° C. (first trial) or 95° C. (second trial).

At a temperature of 109° C. (first trial), good quality granules were obtained. 109° C. is a significantly lower temperature than the temperatures that were applied in example 2 (160° C. and 185° C., respectively). However, at a temperature of 95° C. (second trial), the quality of the obtained granules was significantly reduced.

### Example 4 (20 wt.-% Filler)

In example 4, the experiment of example 3 was repeated. However, the amount of filler was reduced from 40 wt.-% to 20 wt.-%. The amount of active ingredient was increased accordingly.

In example 4, the weight ratio between filler and binder was 2:1. The composition of the dry mixture of example 4 is shown below:

| | Amount (wt.-%, based on total weight of |
|---|---|
| Ingredient | granule) |
| Ascorbic acid (fine powder) | 70 wt.-% |
| Binder (sorbitol) | 10 wt.-% |
| Filler (Inulin) | 20 wt.-% |
| Total | 100 wt.-% |

In example 4, temperature zones closer to the powder inlet of the extruder (zones 2, 3 and 4) were heated to a temperature of only 94° C. Despite of this relatively low temperature and in contrast to the second trial of example 3, good quality granules were obtained. The process was stable such that granules were continuously being churned out over a period of more than 1 hour (long run).

Example 4 shows how good quality granules with high potency can be continuously manufactured at a surprisingly low temperature and without the need for any cutting and/or drying step. The extruder operates in a steady state, resulting in a continuous flow which saves costs, energy and time.

Process can be adapted more efficiently to the needs of customers than batch processing. Errors are easier to identify and correct and thus, waste can be reduced and/or quality can be improved. There is no need for complicated downstream processing.

1. A mixture comprising an active ingredient, a filler and a binder,
wherein the mixture comprises at least 50 weight-% active ingredient, based on the total weight of the mixture, and
wherein the mixture comprises at least 10 weight-% filler, based on the total weight of the mixture, and
wherein the melting temperature of the active ingredient is higher than the melting temperature of the binder, and
wherein the melting temperature of the binder is lower than the melting temperature of the filler, and
wherein the mixture comprises less than 5 weight-% water, based on the total weight of the mixture.

2. The mixture according to claim 1, wherein the mixture comprises at least 15 weight-% filler, based on the total weight of the mixture.

3. The mixture according to claim 1, wherein the mixture comprises from 15 weight-% to 25 weight-% filler, based on the total weight of the mixture.

4. The mixture according to claim 1, wherein the active ingredient is not a synthetic drug.

5. The mixture according to claim 1, wherein the active ingredient is a micronutrient.

6. The mixture according to claim 1, wherein the active ingredient is a water-soluble micronutrient.

7. The mixture according to claim 1, wherein the active ingredient is a water-soluble vitamin.

8. The mixture according to claim 1, wherein the mixture comprises:
from 50 to 80 weight-% ascorbic acid and preferably from 65 to 75 weight-% ascorbic acid, based on the total weight of the mixture,
15 to 25 weight-% filler, based on the total weight of the mixture,
from 5 to 15 weight-% binder, based on the total weight of the mixture, and
less than 2 weight-% water, based on the total weight of the mixture.

9. The mixture according to claim 1, wherein the weight ratio between filler and binder is from 4:1 to 1:1, preferably from 3:1 to 1:1, more preferably from 2:1 to 1:1, and most preferably 2:1.

10. The mixture according to claim 1, wherein the filler is a polysaccharide being preferably inulin.

11. The mixture according to claim 1, wherein the binder is a sugar alcohol being preferably sorbitol.

12. The mixture according to claim 1, wherein the filler is a polysaccharide being preferably inulin and the binder is a sugar alcohol being preferably sorbitol.

13. The mixture according to claim 1, wherein the active ingredient is ascorbic acid, an edible salt thereof or water-soluble ester thereof.

14. Granules comprising the mixture according to claim 1.

15. Granules consisting of the mixture according to claim 1.

16. Granules according to claim 14, wherein the granules have a mass median particle size D50 (volume based) from 0.5 mm to 6 mm, preferably from 1 mm to 5 mm, more preferably from 1.5 mm to 4.5 mm and most preferably from 2 mm to 4 mm, measured using dynamic image analysis.

17. Granules according to claim 14, wherein the granules are obtainable by continuous melt granulation of the mixture according to any one of claims 1-13, preferably by continuous melt granulation using a twin-screw extruder.

18. Granules according to claim 14, wherein the granules are water-soluble or water-dispersible.

19. Use of the mixture according to claim 1 for continuous melt granulation.

20. A method of manufacturing granules comprising the step of feeding the mixture according to claim 1 into an extruder that has at least one kneading zone.

21. The method according to claim 20, wherein the extruder is a twin-screw extruder that has no cutting device.

22. The method according to claim 20, wherein the method does not comprise the step of cutting an extruded strand.

23. The method according to claim 20, wherein the kneading zone has at least two, preferably at least three kneading elements that are preferably positioned at a stagger angle of from 30° to 90°.

24. The method according to claim 20, wherein at least one zone of the extruder is heated, preferably to a temperature from 80° C. to 180° C., more preferably to a temperature from 80° C. to 110° C. and most preferably to a temperature from 90° C. to 100° C.

25. Granules obtained by the method of claim 20.
